(19) United States
(12) Patent Application Publication
(10) Pub. No.: US 2021/0364734 A1
(43) Pub. Date: Nov. 25, 2021

(54) VEHICLE HEAD-UP DISPLAY DEVICE HAVING EXTERNAL LIGHT BLOCKING FUNCTION

(71) Applicant: HYUNDAI MOBIS CO., LTD., Seoul (KR)

(72) Inventor: Byung Ki KIM, Yongin-si (KR)

(73) Assignee: HYUNDAI MOBIS CO., LTD., Seoul (KR)

(21) Appl. No.: 17/323,643

(22) Filed: May 18, 2021

(30) Foreign Application Priority Data
May 19, 2020 (KR) 10-2020-0059709

(51) Int. Cl. G02B 7/182; G02B 27/01; G02B 5/10; G02B 26/08; B60K 35/00

(52) U.S. Cl. CPC G02B 7/1821; G02B 27/0101; G02B 5/10; B60K 2370/23; B60K 35/00; B60K 2370/1529; G02B 26/0816

(57) ABSTRACT

A vehicle head-up display (HUD) device includes a case, a screen part disposed inside the case, an aspheric mirror disposed on one side of the screen part, a folding mirror part disposed above the other side of the screen part, a light-emitting display disposed below the other side of the screen part, and an actuator that changes a reflective surface of the folding mirror part by operating the folding mirror part, wherein light emitted by the light-emitting display is displayed externally due to the folding mirror part and the aspheric mirror, and when the reflective surface of the folding mirror part is changed by the actuator, an irradiation direction of external light incident on the light-emitting display due to the aspheric mirror and the folding mirror part is changed to externally of the light-emitting display.

### CROSS-REFERENCE TO RELATED APPLICATION

This application claims priority to and the benefit of Korean Patent Application No. 10-2020-0059709, filed on May 19, 2020, the disclosure of which is incorporated herein by reference in its entirety.

### BACKGROUND

### 1. Field of the Invention

The present disclosure relates to a vehicle head-up display device having an external light blocking function and, more particularly, to a vehicle head-up display device having an external light blocking function which may block external light from being irradiated to an image generator.

### 2. Discussion of Related Art

In recent years, the vehicle market is rapidly growing with the trend of favoring intelligent vehicles equipped with advanced information technology (IT) and convenience functions as well as unique improvement of vehicles.

In this trend, as the vehicles become electrified, functions, in which an IT technology and a wireless communication technology are combined, are rapidly increasing.

In particular, products that support a driver's stability and convenience are being released, and among them, vehicle head-up displays (HUDs) are being spotlighted as a variety of product lines.

In general, the vehicle HUDs are devices that display, on windshields that are front windows of the vehicles, images including vehicle speeds, remaining fuel amounts, road guidance information, and the like.

Such vehicle HUD devices are equipped with picture generation units (PGUs) that generate vehicle information through light, and when such PGUs are irradiated with strong external light, the PGUs may be damaged.

Thus, technologies have been developed in which, when the HUDs are not used or the PGUs are irradiated with strong external light, the PGUs are not irradiated with external light.

However, there is still a problem in that, in the HUD devices having a light shielding structure according to the related art, the external light being irradiated to the PGUs cannot be efficiently blocked.

### SUMMARY OF THE INVENTION

The present disclosure is directed to solving the above-described problems, and the purpose of the present disclosure is to provide a vehicle head-up display (HUD) device having an external light blocking function capable of preventing damage to a picture generation unit (PGU) by blocking external light from being irradiated to the PGU.

A vehicle head-up display (HUD) device includes a case, a screen part disposed inside the case, an aspheric mirror disposed on one side of the screen part, a folding mirror part disposed above the other side of the screen part, a PGU disposed below the other side of the screen part, and an actuator that changes a reflective surface of the folding mirror part by operating the folding mirror part, wherein light emitted by the PGU is displayed externally due to the folding mirror part and the aspheric minor, and when the reflective surface of the folding minor part is changed by the actuator, an irradiation direction of external light incident on the PGU due to the aspheric minor and the folding mirror part is changed to externally of the PGU.

The folding minor part may be rotatably mounted on the screen part, and the actuator may rotate the folding mirror part with respect to the screen part to change an angle of the reflective surface of the folding mirror part.

The actuator may have one end coupled to the screen part and the other and connected to one end of the folding mirror part, and by operating the actuator, the folding minor part may rotate with respect to the screen part about a rotation axis.

The folding minor part may be mounted on the screen part to be vertically rotatable.

The actuator may have a solenoid structure and thus have a length that changes when power is applied, and the folding minor part may rotate due to the change in the length of the actuator.

The vehicle HUD device may further include a spring elastically deformed due to the change in the length of the actuator, wherein, when the power is applied to change the length of the actuator, the spring is elastically deformed, and when the power applied to the actuator is removed, the length of the actuator returns to an original length due to an elastically restoring force of the spring

The folding minor part may include a minor portion having a reflective surface and a frame portion coupled to a circumference of the minor portion. Both sides of the frame portion may be rotatably mounted on the screen part, a coupling protrusion may protrude from one end of the frame portion, and the other end of the actuator may be rotatably coupled to the coupling protrusion.

The coupling protrusion may have a long coupling hole to which the other end of the actuator is coupled, and when the folding mirror part rotates by operating the actuator, the other end of the actuator may move inside the coupling hole.

The vehicle HUD device may further include a bracket that couples the frame portion to the screen part, wherein the bracket has one end coupled to the screen part and the other end to which both sides of the frame portion are rotatably coupled.

The bracket may include a support plate coupled to the screen part and a connection part that is bent upward from the support plate, and both sides of the frame portion may be rotatably coupled to an upper portion of the connection part.

The vehicle HUD device may further include a spring having one end coupled to the other end of the frame portion and the other end coupled to the bracket, wherein, when the folding mirror part rotates in one direction due to the actuator, the spring is elastically deformed, and when an external force applied to the actuator is removed, the folding mirror part rotates in the other direction due to an elastically restoring force of the spring and thus returns to an original position.

In a state in which the power is not applied to the actuator, the light generated by the PGU may be displayed externally due to the folding mirror part and the aspheric mirror, and the PGU may be irradiated with the external light incident due to the aspheric mirror and the folding mirror part, and in a state in which the power is applied to the actuator and thus the folding mirror part rotates in one direction, an irradiation direction of the external light incident due to the aspheric mirror and the folding mirror part may be changed, and thus the PGU may not be irradiated with the external light.

A vehicle HUD device includes a case, a screen part disposed inside the case, an aspheric mirror disposed on one side of the screen part, a folding mirror part disposed above the other side of the screen part to be vertically rotatable, a PGU disposed below the other side of the screen part, and an actuator that has one end coupled to the screen part and the other end coupled to one end of the folding mirror part and rotates the folding mirror part to change an angle of a reflective surface of the folding mirror part, wherein light generated by the PGU is displayed externally due to the folding mirror part and the aspheric mirror, the actuator has a structure of which a length changes, and as the folding mirror part rotates due to the change in the length of the actuator, the reflective surface changes, and thus an irradiation direction of external light incident on the PGU due to the aspheric mirror and the folding mirror part is changed externally to externally of the PGU.

The actuator has a solenoid structure and thus has a length that changes when power is applied.

A coupling protrusion is formed at one end of the folding mirror part, and the other end of the actuator is rotatably coupled to the coupling protrusion.

The coupling protrusion may have a long coupling hole to which the other end of the actuator is coupled, and when the folding mirror part rotates by operating the actuator, the other end of the actuator may move inside the coupling hole.

The vehicle HUD device may further include a bracket that couples the folding mirror part to the screen part, wherein the bracket has one end coupled to the screen part and the other end to which both sides of the folding mirror part are rotatably coupled.

The vehicle HUD device may further include a spring having one end coupled to the other end of the folding mirror part and the other end coupled to the bracket, wherein, when the folding minor part rotates in one direction due to the actuator, the spring is elastically deformed, and when an external force applied to the actuator is removed, the folding mirror part rotates in the other direction by an elastically restoring force of the spring and thus returns to an original position.

In a state in which the power is not applied to the actuator, the light generated by the PGU may be displayed externally due to the folding minor part and the aspheric mirror, and the PGU may be irradiated with the external light incident due to the aspheric mirror and the folding minor part, and in a state in which the power is applied to the actuator and thus the folding minor part rotates in one direction, an irradiation direction of the external light incident due to the aspheric mirror and the folding mirror part may be changed, and thus the PGU may not be irradiated with the external light.

A vehicle HUD device includes a case, a screen part disposed inside the case, an aspheric mirror disposed on one side of the screen, a folding minor part disposed above the other side of the screen part to be vertically rotatable, a PGU disposed below the other side of the screen part, and an actuator coupled to one end of the folding mirror part to rotate the folding minor part so as to change an angle of a reflective surface of the folding minor part, wherein, in a state in which power is not applied to the actuator, light generated by the PGU is displayed externally due to the folding minor part and the aspheric mirror, and the PGU is irradiated with external light incident due to the aspheric mirror and the folding minor part, and in a state in which the power is applied to the actuator and the folding minor part rotates in one direction, an irradiation direction of the external light incident due to the aspheric minor and the folding mirror part is changed, and thus the PGU is not irradiated with the external light.

The vehicle HUD device may further include a spring having one end coupled to the other end of the folding mirror part and the other end coupled to the screen part, wherein, when the folding mirror part rotates in one direction due to the actuator, the spring is elastically deformed, and when an external force applied to the actuator is removed, the folding mirror part rotates in the other direction due to an elastically restoring force of the spring and thus returns to an original position.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view illustrating a state before a folding mirror part is rotated in a head-up device (HUD) device according to an embodiment of the present disclosure;

FIG. 2 is a perspective view illustrating a state in which the folding mirror part of FIG. 1 is rotated and an irradiation direction of external light is changed;

FIG. 3 is a side cross-sectional perspective view of a state illustrated in FIG. 1;

FIG. 4 is a side cross-sectional perspective view of a state illustrated in FIG. 2;

FIG. 5 is a perspective view illustrating the folding mirror part and an actuator in the state illustrated in FIG. 1;

FIG. 6 is a perspective view illustrating the folding mirror part and the actuator in the state illustrated in FIG. 2;

FIG. 7 is a perspective view of the folding mirror part and the actuator in another direction according to the embodiment of the present disclosure;

FIG. 8 is a side view illustrating the positions of the actuator and a coupling protrusion in the state illustrated in FIG. 5; and

FIG. 9 is a side view illustrating the positions of the actuator and the coupling protrusion in the state illustrated in FIG. 6.

### DETAILED DESCRIPTION OF EXEMPLARY EMBODIMENTS

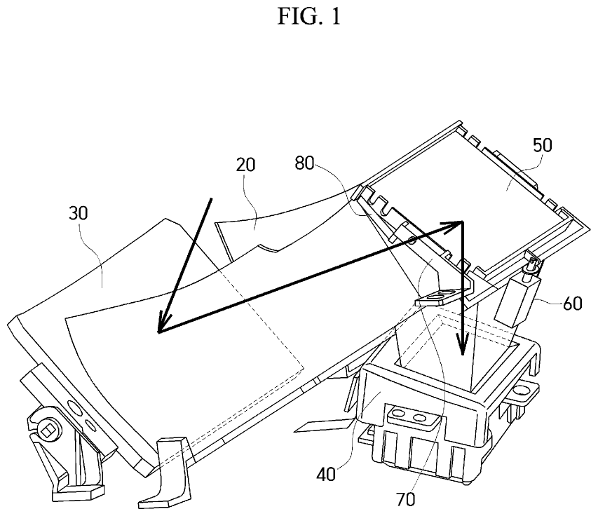

As illustrated in FIGS. 1 to 4, a vehicle head-up display (HUD) device includes a case (not illustrated), a screen part 20, an aspheric mirror 30, a folding mirror part 50, a picture generation unit (PGU) 40, and an actuator 60.

The case is a part constituting the overall appearance of the HUD device.

The screen part 20 is disposed inside the case.

The aspheric mirror 30 is disposed on one side of the screen part 20.

The folding mirror part 50 is disposed above the other side of the screen part 20.

A reflective surface is formed on the folding mirror part 50.

The PGU 40 is disposed below the other side of the screen part 20.

Light generated by the PGU 40 is reflected by the aspheric mirror 30 and is displayed on a windshield of a vehicle.

The PGU 40 includes both of a light-emitting display, such as a laser or a diode, and a light-receiving display such as a liquid crystal display.

The actuator 60 operates the folding mirror part 50 using applied power to change the reflective surface of the folding mirror part 50.

Since the case, the screen part 20, the aspheric mirror 30, and the PGU 40 are the same as or similar to those of a widely-known technology according to the related art, a detailed description thereof will be omitted, and the folding mirror part 50 and the actuator 60 will be mainly described below.

The folding mirror part 50 may be slidably mounted on the screen part 20 or the like to change the reflective surface. However, as in the present embodiment, the folding mirror part 50 may be rotatably mounted on the screen part 20 so that an angle of the reflective surface of the folding mirror part 50 may be changed by the rotation of the folding mirror part 50.

Normally, the light generated by the PGU 40 is displayed externally due to the folding mirror part 50 and the aspheric mirror 30.

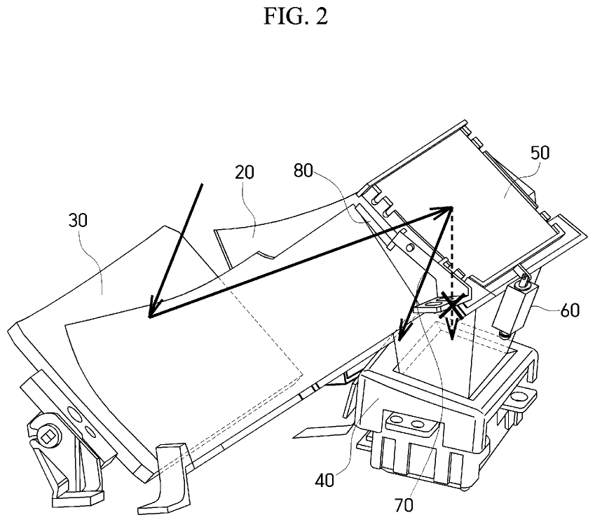

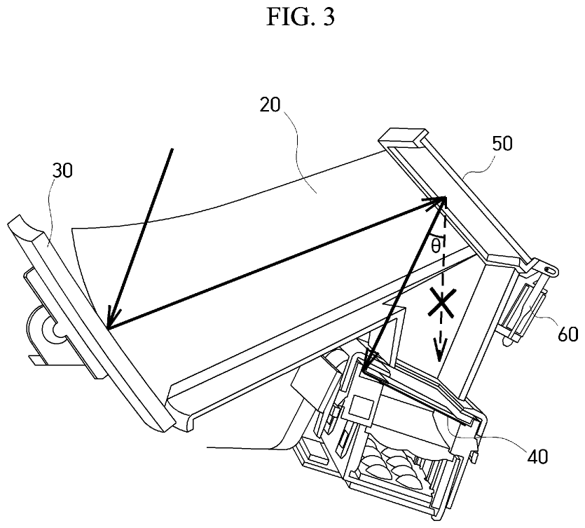

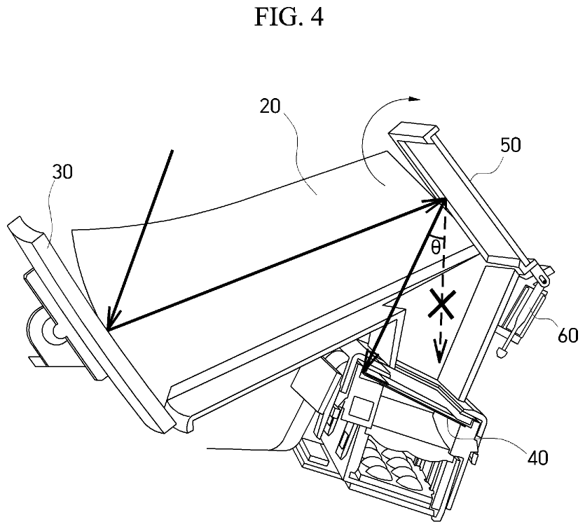

Then, as illustrated in FIGS. 1 and 3, through a separate sensor or the like, when it is detected that the PGU 40 is irradiated with external light (indicated by an arrow) incident due to the aspheric mirror 30 and the folding mirror part 50, that is, when a sun burn is detected, as illustrated in FIGS. 2 and 4, the actuator 60 rotates the folding mirror part 50 with respect to the screen part 20 to change the angle of the reflective surface of the folding mirror part 50.

As described above, when the reflective surface of the folding mirror part is changed by the actuator 60, as the irradiation direction of the external light (indicated by arrow) incident on the PGU 40 through the aspheric mirror 30 and the folding mirror part 50 is changed to externally of the PGU 40, the PGU 40 is not irradiated with the external light.

Alternatively, when the vehicle is parked, a reflection angle of the reflective surface of the folding mirror part 50 is changed, and thus the PGU 40 may be prevented from being irradiated with the external light.

The folding minor part 50 may be mounted on the screen part 20 to be rotatable in a left-right direction. However, in the present embodiment the folding mirror part 50 is mounted on the screen part 20 to be vertically rotatable.

Thus, the folding minor part 50 rotates vertically with respect to the screen part 20, and thus the reflection angle thereof is changed.

As illustrated in FIGS. 1 and 3, in a state before the folding mirror part 50 is rotated, the PGU 40 may be irradiated with the external light reflected due to the folding mirror part 50. However, as illustrated in FIGS. 2 and 4, when the folding mirror part is rotated, as the reflection angle of the folding mirror part 50 is changed, the external light is blocked from being irradiated to the PGU 40 and thus the PGU 40 can be prevented from being damaged by the strong external light.

Although the actuator 60 for rotating the folding mirror part 50 may include various components, as in the present embodiment, the actuator 60 may include components whose lengths are variable.

In particular, the actuator 60 may have a solenoid structure in the interior thereof, the length thereof may be changed when power is applied, and thus the folding minor part 50 may be rotated by a change in the length of the actuator 60.

Since the structure of the solenoid-type actuator is widely known, a detailed description thereof will be omitted.

Since the actuator 60 has the solenoid structure in the interior thereof, through a separate sensor or the like, when it is detected that the PGU 40 is irradiated with the external light incident due to the aspheric minor 30 and the folding minor part 50, that is, when a sun burn is detected, the reflection angle of the folding mirror part 50 is changed by the actuator 60 within a very short time, and thus the PGU 40 may not be irradiated with the external light.

The actuator 60 has one end coupled to the screen part 20 and the other end coupled to one end of the folding mirror part 50, and by operating the actuator 60, the folding mirror part 50 rotates with respect to the screen part 20 about a rotation axis.

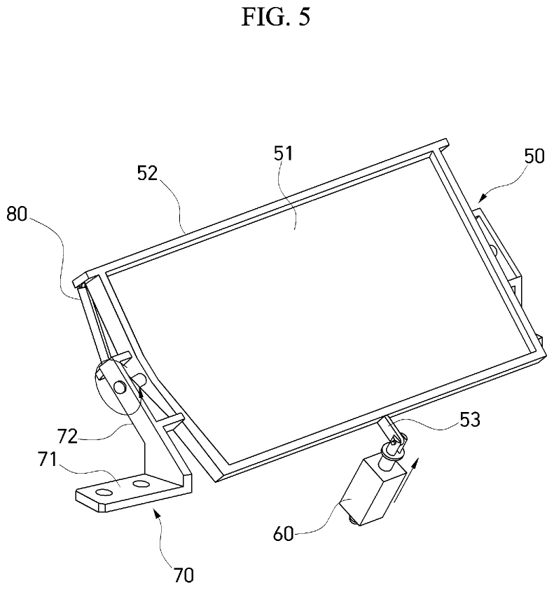

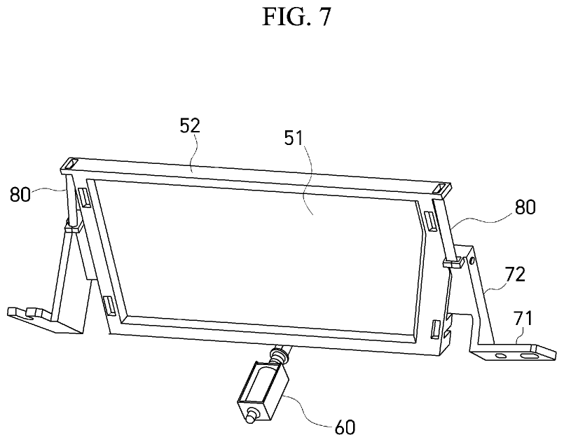

In the drawing of the present embodiment, as illustrated in FIGS. 5 to 7, the folding mirror part 50 includes a mirror portion 51 having a reflective surface and a frame portion 52 coupled to the circumference of the mirror portion 51.

However, the mirror portion 51 and the frame portion 52 are integrally formed so that the folding mirror part 50 may be formed as a single component.

Rotary shafts are formed on both sides of the frame portion 52, and thus the folding mirror part 50 is rotatably mounted on the screen part 20.

A coupling protrusion 53 protrudes from one end of the frame portion 52.

Further, the other end of the actuator 60 is rotatably coupled to the coupling protrusion 53.

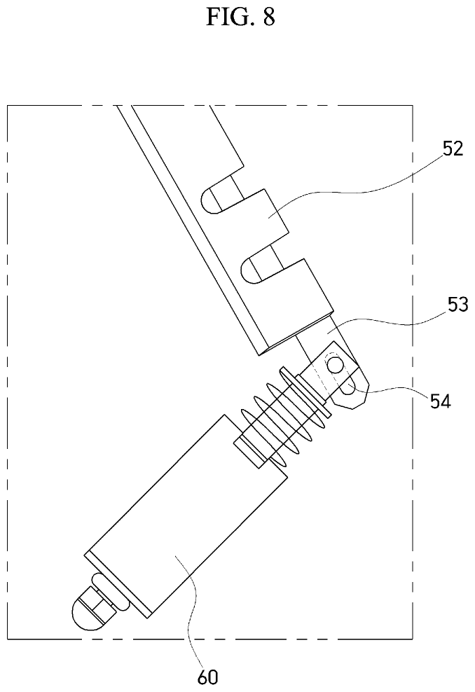

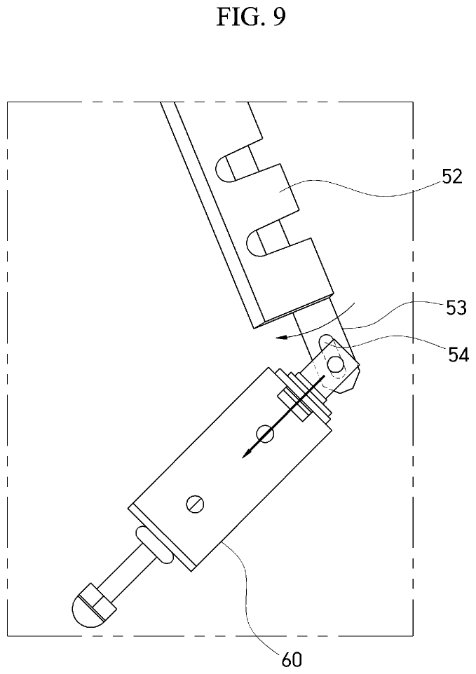

As illustrated in FIGS. 8 and 9, the coupling protrusion 53 has a long coupling hole 54 to which the other end of the actuator 60 is coupled.

When the folding mirror part 50 rotates by operating the actuator 60, the other end of the actuator 60 moves inside the long coupling hole 54.

The frame portion 52 may be directly coupled to the screen part 20, and as illustrated in the drawings in the present embodiment, the frame portion 52 may be indirectly coupled to the screen part 20 through a bracket 70.

The bracket 70 serves to couple the frame portion 52 to the screen part 20.

The bracket 70 has one end coupled to the screen part 20.

Further, both sides of the frame portion 52 are rotatably coupled to the other end of the bracket 70.

In more detail, the bracket 70 includes a support plate 71 coupled to the screen part 20 and a connection part 72 that is bent upward from the support plate 71.

Both sides of the frame portions 52 are rotatably coupled to an upper portion of the connection part 72.

Further, the present disclosure may further include a spring 80 having one end coupled to the other end of the frame portion 52 and the other end coupled to the bracket 70.

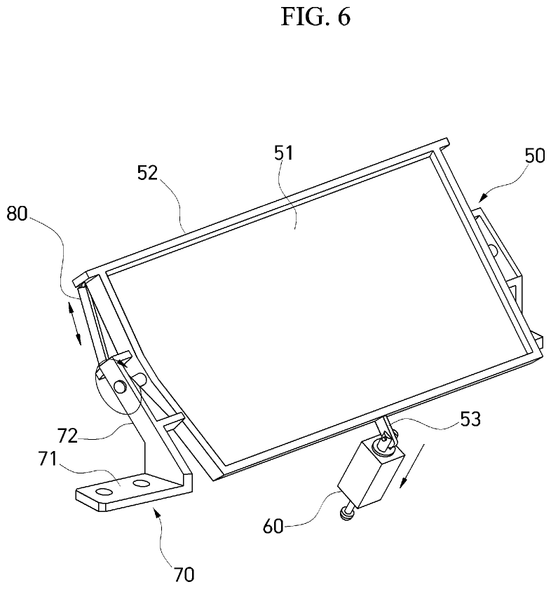

As illustrated in FIG. 6, when the folding mirror part 50 rotates in one direction due to the actuator 60, the spring 80 is elastically deformed. Further, as illustrated in FIG. 5, when an external force applied to the actuator 60 is removed, the folding mirror part 50 rotates in the other direction due to an elastic restoring force of the spring 80 and thus returns to an original position.

In the present embodiment, in the drawing, the spring 80 is coupled to the other end of the frame portion 52 and the bracket 70. However, as long as a component is provided to implement a function, that is, the elastic restoring force, of the spring 80, a coupling target and a structural position of the component may be changed.

In other words, the spring 80 is elastically deformed by a change in the length of the actuator 60. As long as the spring 80 is provided so that when power is applied to the actuator 60 to change the length of the actuator 60, the spring is elastically deformed, and when the power applied to the actuator 60 is removed, the length of the actuator 60 returns to an original state by the elastically restoring force of the spring, a coupling target and a structural position of the spring 80 may be changed.

In the present embodiment, in a state in which the power is not applied to the actuator 60, the light generated by the PGU 40 is displayed externally due to the folding mirror part 50 and the aspheric mirror 30.

Further, the PGU 40 is irradiated with the external light incident due to the aspheric mirror 30 and the folding mirror part 50.

As illustrated in FIGS. 1 and 3, through a separate sensor or the like, when it is detected that the PGU 40 is irradiated with the external light, that is, when a sun burn is detected, the power is applied to the actuator 60.

As illustrated in FIGS. 2 and 6, as the power is applied to the actuator 60, the folding mirror part 50 rotates in one direction while the length of the actuator 60 is changed.

When the folding mirror part 50 rotates in the one direction, as illustrated in FIGS. 2 and 4, the reflection angle of the folding mirror part 50 is changed, the irradiation direction of the external light incident due to the aspheric mirror 30 and the folding mirror part 50 is changed, and thus, the PGU 40 is not irradiated.

Accordingly, the PGU 40 can be prevented from being damaged by irradiating the PGU 40 with the strong external light.

However, when it is determined in a separate controller that a sun burn has ended, and when the power applied to the actuator 60 is blocked, as illustrated in FIG. 5, the folding mirror part 50 rotates in the other direction due to the elastically restoring force of the spring 80 and returns to the original position.

When the folding mirror part 50 returns to the original position, various pieces of guide information of the vehicle generated by the PGU 40 may be displayed on the windshield of the vehicle due to the folding mirror part 50 and the aspheric mirror 30.

As described above, the present disclosure has the effect of, when the sun burn is detected, changing the reflection angle of the folding mirror part 50 and thus is capable of preventing the PGU 40 from being damaged by irradiating the PGU 40 with the external light and has the effect of, when the power applied to the actuator 60 is blocked, causing the folding mirror part 50 to rapidly return to the original position by the elastic restoring force of the spring 80.

A vehicle head-up display (HUD) device having an external light blocking function according to the present disclosure has the following effects.

The present disclosure has the effect of being capable of preventing a PGU from being damaged by irradiating the PGU with external light by changing a reflection angle of a folding mirror part when a sun burn is detected and has the effect of causing the folding mirror part to rapidly return to an original position due to an elastically restoring force of a spring when power applied to an actuator is blocked.

The vehicle HUD device having an external light blocking function according to the present disclosure is not limited to the above-described embodiments and may be various modified without departing from the technical spirit of the present disclosure.

What is claimed is:

1. A vehicle head-up display (HUD) device comprising:
a case;
a screen part disposed inside the case;
an aspheric mirror disposed on a first side of the screen part;
a folding mirror part disposed above a second side of the screen part;
a picture generation unit (PGU) disposed below the second side of the screen part; and
an actuator that changes a reflective surface of the folding mirror part by operating the folding mirror part,
wherein light emitted by the PGU is displayed externally due to the folding mirror part and the aspheric mirror, and
when the reflective surface of the folding mirror part is changed by the actuator, an irradiation direction of external light incident on the PGU due to the aspheric mirror and the folding mirror part is changed to externally of the PGU.

2. The vehicle HUD device of claim 1, wherein the folding mirror part is rotatably mounted on the screen part, and
the actuator rotates the folding mirror part with respect to the screen part to change an angle of the reflective surface of the folding mirror part.

3. The vehicle HUD device of claim 2, wherein the actuator has a first end coupled to the screen part and a second end connected to one end of the folding mirror part, and
by operating the actuator, the folding mirror part rotates about a rotation axis with respect to the screen part.

4. The vehicle HUD device of claim 3, wherein the folding mirror part is mounted on the screen part to be vertically rotatable.

5. The vehicle HUD device of claim 3, wherein the actuator has a solenoid structure and thus a length that changes when power is applied, and
the folding mirror part rotates due to the change in the length of the actuator.

6. The vehicle HUD device of claim 5, further comprising a spring elastically deformed due to the change in the length of the actuator,
wherein, when the power is applied to change the length of the actuator, the spring is elastically deformed, and
when the power applied to the actuator is removed, the length of the actuator returns to an original length thereof due to an elastically restoring force of the spring.

7. The vehicle HUD device of claim 3, wherein the folding mirror part includes a mirror portion having a reflective surface and a frame portion coupled to a circumference of the mirror portion,
first and second sides of the frame portion are rotatably mounted on the screen part,
a coupling protrusion protrudes from a first end of the frame portion, and
a second end of the actuator is rotatably coupled to the coupling protrusion.

8. The vehicle HUD device of claim 7, wherein the coupling protrusion has an elongated coupling hole to which the second end of the actuator is coupled, and
when the folding mirror part rotates by operating the actuator, the second end of the actuator moves inside the coupling hole.

9. The vehicle HUD device of claim 7, further comprising a bracket that couples the frame portion to the screen part,
wherein the bracket has a first end coupled to the screen part and a second end to which the first and second sides of the frame portion are rotatably coupled.

10. The vehicle HUD device of claim 9, wherein the bracket includes:
a support plate coupled to the screen part; and
a connection part bent upwardly from the support plate, and
sides of the frame portion rotatably coupled to an upper portion of the connection part.

11. The vehicle HUD device of claim 9, further comprising a spring having a first end coupled to a second end of the frame portion, the second end of the spring being coupled to the bracket,
wherein, when the folding mirror part rotates in one direction due to the actuator, the spring is elastically deformed, and
when an external force applied to the actuator is removed, the folding mirror part rotates in another direction due to an elastically restoring force of the spring and thus returns to an original position.

12. The vehicle HUD device of claim 11, wherein, in a state in which the power is not applied to the actuator, the light generated by the PGU is displayed externally due to the folding mirror part and the aspheric mirror, and the PGU is irradiated with the external light incident due to the aspheric mirror and the folding mirror part, and
in a state in which the power is applied to the actuator and thus the folding mirror part rotates in the one direction, an irradiation direction of the external light incident due to the aspheric mirror and the folding mirror part is changed, and thus the PGU is not irradiated with the external light.

13. A vehicle head-up display (HUD) device comprising:
a case;
a screen part disposed inside the case;
an aspheric mirror disposed on a first side of the screen part;
a folding mirror part disposed above a second side of the screen part to be vertically rotatable;
a picture generation unit (PGU) disposed below the second side of the screen part; and
an actuator that has a first end coupled to the screen part and a second end coupled to a first end of the folding mirror part and rotates the folding mirror part to change an angle of a reflective surface of the folding mirror part,
wherein light generated by the PGU is displayed externally due to the folding mirror part and the aspheric mirror,
the actuator has a structure of which a length thereof is changeable, and
as the folding mirror part rotates due to a change in the length of the actuator, the reflective surface changes, and thus an irradiation direction of external light incident on the PGU due to the aspheric mirror and the folding mirror part is changed to externally of the PGU.

14. The vehicle HUD device of claim 13, wherein the actuator has a solenoid structure with a length thereof that changes when power is applied.

15. The vehicle HUD device of claim 13, wherein a coupling protrusion is formed at a first end of the folding mirror part, and
a second end of the actuator is rotatably coupled to the coupling protrusion.

16. The vehicle HUD device of claim 15, wherein an elongated coupling hole, to which the other end of the actuator is coupled, is formed in the coupling protrusion, and
when the folding mirror part rotates by operating the actuator, the second end of the actuator moves inside the coupling hole.

17. The vehicle HUD device of claim 13, further comprising a bracket that couples the folding mirror part to the screen,
wherein the bracket has a first end coupled to the screen part and a second end to which both sides of the folding mirror part are rotatably coupled.

18. The vehicle HUD device of claim 17, further comprising a spring having a first end coupled to the second end of the folding mirror part, a second end of the spring being coupled to the bracket,
wherein, when the folding mirror part rotates in a first direction due to the actuator, the spring is elastically deformed, and
when an external force applied to the actuator is removed, the folding mirror part rotates in a second direction by an elastically restoring force of the spring and thus returns to an original position.

19. The vehicle HUD device of claim 18, wherein, in a state in which power is not applied to the actuator, the light generated by the PGU is displayed externally due to the folding mirror part and the aspheric mirror, and the PGU is irradiated with the external light incident due to the aspheric mirror and the folding mirror part, and
in a state in which the power is applied to the actuator and thus the folding mirror part rotates in the second direction, an irradiation direction of the external light incident due to the aspheric mirror and the folding mirror part is changed and thus the PGU is not irradiated with the external light.

20. A vehicle head-up display (HUD) device comprising:
a case;
a screen part disposed inside the case;
an aspheric mirror disposed on a first side of the screen part;
a folding mirror part disposed above a second side of the screen part to be vertically rotatable;
a picture generation unit (PGU) disposed below the second side of the screen part; and
an actuator coupled to a first end of the folding minor part to rotate the folding minor part so as to change an angle of a reflective surface of the folding mirror part,
wherein, in a state in which power is not applied to the actuator, light generated by the PGU is displayed externally due to the folding mirror part and the aspheric minor, and the PGU is irradiated with external light incident due to the aspheric mirror and the folding minor part, and
in a state in which the power is applied to the actuator and the folding minor part rotates in a first direction, an irradiation direction of the external light incident due to the aspheric mirror and the folding mirror part is changed, and thus the PGU is not irradiated with the external light.

21. The vehicle HUD device of claim 20, further comprising a spring having a first end thereof coupled to a second end of the folding minor part and a second end thereof coupled to the screen part,
wherein, when the folding mirror part rotates in first direction due to the actuator, the spring is elastically deformed, and
when an external force applied to the actuator is removed, the folding minor part rotates in the second direction due to an elastically restoring force of the spring and thus returns to an original position.
